(19) United States
(12) Patent Application Publication
(10) Pub. No.: US 2008/0077745 A1
(43) Pub. Date: Mar. 27, 2008

(54) Data processing device

(75) Inventors: Teppei Hirotsu, Hitachi (JP); Kotaro Shimamura, Hitachinaka (JP); Yasuo Watanabe, Hitachiota (JP)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Renesas Technology Corp., Tokyo (JP)

(21) Appl. No.: 11/890,902

(22) Filed: Aug. 7, 2007

(30) Foreign Application Priority Data
Sep. 26, 2006 (JP) 2006-260177

(51) Int. Cl. G06F 12/02

(52) U.S. Cl. 711/147; 711/E12.013

(57) ABSTRACT

A data processing device that does not depend on the type of data, has wide application range, and can reduce memory access in data transfer via a buffer arranged in a memory is provided. In a data processing device including a plurality of data processing units and a memory commonly accessed by the data processing units, the data processing units transfer the transfer data via the memory, the transfer data and the compressed data of the transfer data are held in the memory. When read request for the data is issued, the compressed data is expanded and the expanded data is stored in the expanding data buffer. While the compressed data is being expanded, the original data is read from the memory, and after the expanded data is stored in the expanding data buffer, the expanded data is read from the expanding data buffer.

### CROSS-REFERENCE TO RELATED APPLICATION

The present application claims priority from Japanese Patent Application No. JP2006-260177 filed on Sep. 26, 2006, the content of which is hereby incorporated by reference into this application.

### TECHNICAL FIELD OF THE INVENTION

The present invention relates to a technology for a data processing device. More particularly, it relates to a technology effectively applied to data transfer among a plurality of data processing units.

### BACKGROUND OF THE INVENTION

With the recent development in performance and multifunctionality of information devices, the amount of data to be processed by SoC (Systems on a Chip) mounted on such devices has been increasing. In order to handle such increasing data processes, a configuration in which a plurality of data processing units perform data processing in parallel and proceed with the overall process while transferring the processed data with each other has been adopted in the recent Soc.

In the data transfer among the plurality of data processing units in the SoC, a buffer is used to bridge the gap in data processing timing, and the data transfer is performed through the buffer. Generally, the buffer is an external memory such as SDRAM to be attached to the SoC to ensure capacity. Since the number of pins for connecting the SoC and the external memory is limited, the data transfer throughput between the SoC and the external memory is limited, and thus, it is necessary to avoid such limitation in order to enhance the performance of the system.

For example, Japanese Patent Application Laid-Open Publication No. 2002-140232 (Patent Document 1) proposes a method in which a shared bit S indicating that the data of a certain line is shared by a plurality of processors is provided on each line of a shared cache in a multiprocessor system, and when replacing the line, the line that is not shared is replaced with reference to the value of S. According to the method, the data being shared by a plurality of processors is preferentially held in the shared cache and accesses to the external memory resulting from the data transfer of a plurality of processors can be reduced. As a result, the limitation of data transfer throughput between the SoC and the external memory can be avoided.

### SUMMARY OF THE INVENTION

Incidentally, in the technology disclosed in Patent Document 1, the effect changes greatly depending on the hit rate of the shared cache of the data being shared by a plurality of processors. For example, when it is applied to data processing that does not have reusability such as video streaming data, the hit rate of the shared cache is reduced, and the effect of the technology disclosed in Patent Document 1 is small.

Therefore, an object of the present invention is to provide a data processing device that can overcome such problems, does not depend on the type of data, has wide application range, and can reduce memory access in the data transfer through the buffer disposed in the memory.

The above and other objects and novel characteristics of the present invention will be apparent from the description of this specification and the accompanying drawings.

The typical ones of the inventions disclosed in this application will be briefly described as follows.

As means for achieving the above-described object, in the present invention, a data processing device comprises: a plurality of data processing units; and a memory commonly accessed by the plurality of data processing units, in which the plurality of data processing units transfer transfer data via the memory, wherein the memory holds the transfer data and compressed data of the transfer data.

Further, in the present invention, the data processing device further comprises an expanding data buffer which includes a plurality of entries each configured of a set of: a storage element TAG for holding area information where the transfer data is to be stored; a storage element CADR for holding an address of the compressed data; a storage element DATA for holding the transfer data; a storage element DV for holding a state indicating whether the transfer data is valid or invalid; and a storage element ST for holding a state indicating whether the transfer data is expanding or not expanding.

Further, in the present invention, when generating the compressed data of the transfer data and writing the compressed data to the memory, one entry is selected from the plurality of entries of the expanding data buffer, and the area information where the transfer data is to be stored and the address of the compressed data are respectively stored in the TAG and the CADR of the selected entry.

Further, in the present invention, when the data processing unit reads the transfer data from the memory, an entry in which an area indicated by the TAG thereof contains the address of the transfer data is searched from the plurality of entries, if the entry exists, the CADR, the DV, and the ST of the entry are read, when the read DV indicates an invalid state and the read ST indicates a not expanding state, the expansion of the compressed data at the address indicated by the CADR starts, and simultaneously, a state indicating an expanding state is set to the ST of the entry, and when generation of the expanded data is completed, the expanded data is stored in the DATA of the entry, and simultaneously, a state indicating a valid state is set to the DV of the entry.

Further, in the present invention, when the data processing unit reads the transfer data from the memory, an entry in which the area indicated by the TAG thereof contains the address of the transfer data is searched from the plurality of entries, if the entry exists, the DV of the entry is read, when the read DV indicates the valid state, the data processing unit reads the expanded data from the DATA of the entry, and when the read DV indicates the invalid state or if the entry does not exist, the data processing unit reads the transfer data from the memory.

As another means for achieving the above-described object, in the present invention, a data processing device comprises: a plurality of data processing units; and a memory commonly accessed by the plurality of data processing units, in which the plurality of data processing units transfer transfer data via the memory, wherein the memory holds the transfer data, compressed data of the transfer data, and expansion descriptor which is information for expanding the compressed data.

Further, in the present invention, the data processing device further comprises an expanding data buffer which includes a plurality of entries each configured of a set of: a storage element TAG for holding area information where the transfer data is to be stored; a storage element CADR for holding an address of the expansion descriptor; a storage element DATA for holding the transfer data; a storage element DV for holding a state indicating whether the transfer data is valid or invalid; and a storage element ST for holding a state indicating whether the transfer data is expanding or not expanding.

Further, in the present invention, when generating the compressed data of the transfer data and writing the compressed data to the memory, one entry is selected from the plurality of entries of the expanding data buffer, and the area information where the transfer data is to be stored and an address of the expansion descriptor are respectively stored in the TAG and the CADR of the selected entry.

Further, in the present invention, when the data processing unit reads the transfer data from the memory, an entry in which an area indicated by the TAG thereof contains the address of the transfer data is searched from the plurality of entries, if the entry exists, the CADR, the DV, and the ST of the entry are read, when the read DV indicates an invalid state and the read ST indicates a not expanding state, the expansion of the compressed data starts in accordance with a content of the expansion descriptor at the address indicated by the CADR, and simultaneously, a state indicating an expanding state is set to the ST of the entry, and when generation of the expanded data is completed, the expanded data is stored in the DATA of the entry, and simultaneously, a state indicating a valid state is set to the DV of the entry.

Further, in the present invention, when the data processing unit reads the transfer data from the memory, an entry in which the area indicated by the TAG thereof contains the address of the transfer data is searched from the plurality of entries, if the entry exists, the DV of the entry is read, when the read DV indicates the valid state, the data processing unit reads the expanded data from the DATA of the entry, and when the read DV indicates the invalid state or if the entry does not exist, the data processing unit reads the transfer data from the memory.

The effects obtained by typical aspects of the present invention will be briefly described below.

According to the present invention, when the data processing unit reads the data in the memory, the compressed data of the data is expanded as necessary and read, and therefore the reduction in the amount of memory access equivalent to the data compression can be achieved regardless of the features of the data.

Further, according to the present invention, since the expansion descriptor is used when expanding the compressed data, compressed data having different compression rate and format can be handled.

Furthermore, according to the present invention, since the original data that is not compressed is read during the time when the compressed data is expanded and the expanded data is stored in the expanding data buffer, latency to expand the compressed data is concealed. Therefore, it can be applied to the data transfer of high real-time property.

### BRIEF DESCRIPTIONS OF THE DRAWINGS

FIG. 1 is a view showing an entire configuration of a data processing device according to first and second embodiments of the present invention;

FIG. 2 is a view showing an arrangement example on a memory of the data handled by the data processing device according to the first embodiment of the present invention;

FIG. 3 is a view showing the state of an expanding data buffer when data is written to the data memory handled by the data processing device according to the first embodiment of the present invention;

FIG. 4 is a timing chart when the data processing unit 1 reads data D0 of addresses 1000 to 10FC in the data processing device according to the first embodiment of the present invention;

FIG. 5 is a view showing the state of the expanding data buffer in cycle 3 of FIG. 4 in the data processing device according to the first embodiment of the present invention;

FIG. 6 is a view showing the state of the expanding data buffer in cycle 39 of FIG. 4 in the data processing device according to the first embodiment of the present invention;

FIG. 7 is a view showing an arrangement example on a memory of the data handled by the data processing device according to the second embodiment of the present invention;

FIG. 8 is a view showing details of expansion descriptors DS0 and DS1 in the data processing device according to the second embodiment of the present invention;

FIG. 9 is a view showing the state of an expanding data buffer when data is written to the data memory handled by the data processing device according to the second embodiment of the present invention;

FIG. 10 is a timing chart showing the expansion of D0 from CD0 by the expanding data buffer when the data processing unit 1 reads data Do of addresses 1000 to 10FC in the data processing device according to the second embodiment of the present invention; and

FIG. 11 is a timing chart showing the expansion of D1 from CD1 by the expanding data buffer when the data processing unit 1 reads data D1 of addresses 1100 to 11FC in the data processing device according to the second embodiment of the present invention.

### DESCRIPTIONS OF THE PREFERRED EMBODIMENTS

Hereinafter, embodiments of the present invention will be described in detail with reference to the accompanying drawings. Note that components having the same function are denoted by the same reference symbols throughout the drawings for describing the embodiment, and the repetitive description thereof will be omitted.

### First Embodiment

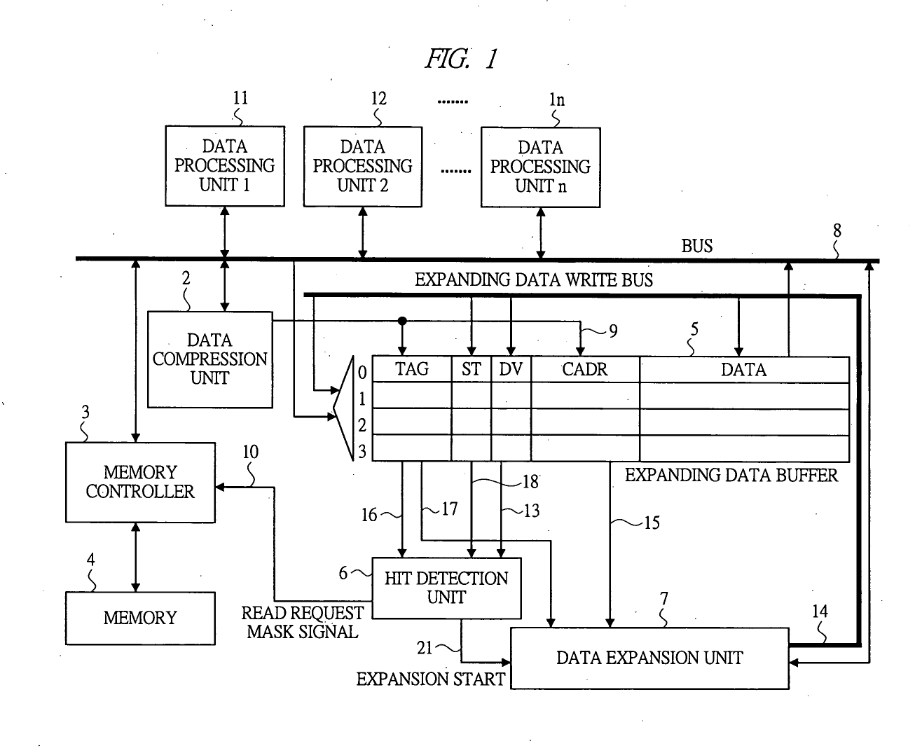

FIG. 1 is a view showing an entire configuration of a data processing device according to a first embodiment of the present invention.

The data processing device of the present embodiment is configured of a plurality of data processing units, that is, a data processing unit 1 (11), a data processing unit 2 (12), and a data processing unit n (1n), a data compression unit (2), a memory controller (3), a memory (4), an expanding data buffer (5), a hit detection unit (6), a data expansion unit (7), a bus (8), and the like.

The data processing unit 1 (11), the data processing unit 2 (12), . . . , and the data processing unit n (in) perform data processing while reading and writing transfer data stored in the memory (4) by way of the bus (8) and the memory controller (3). A specific example of the data processing unit is a CPU and a computing unit specialized for a specific process. Further, in the present embodiment, the data processing units perform the reading from and the writing to the memory (4) by byte addressing.

The data processing unit 1 (11), the data processing unit 2 (12), . . . , and the data processing unit n (1n), the memory controller (3), the data compression unit (2), the hit detection unit (6), the data expansion unit (7), and the expanding data buffer (5) are connected to the bus (8), through which data transfer among them is performed. Although the bus (8) includes address, control signal, and data, they are illustrated in a summarized manner in the present embodiment. Further, the bus (8) has a width of 32 bits for both address and data in the present embodiment.

The memory controller (3) decodes read and write requests on the bus (8) and inputs/outputs a signal complying with the interface of the memory (4) to/from the memory (4), thereby reading the data corresponding to the read request of the bus (8) from the memory (4) or writing the write data of the bus (8) to the memory (4). Further, the memory controller (3) ignores the read request of the bus (8) when a read request mask signal (10) from the hit detection unit (6) is asserted, and instead, reads the data from the expanding data buffer (5).

The expanding data buffer (5) includes a plurality of entries each consisting of a set of a storage element TAG for holding the area information of the expanding data, a storage element CADR for holding the address of the compressed data, a storage element DATA for holding the expanding data, a storage element DV for holding the state indicating whether the storage element DATA is valid or invalid (1: valid, 0: invalid), and a storage element ST for holding the state indicating whether the expanding data is expanding or not expanding (1: expanding, 0: not expanding). The respective storage elements are denoted as TAG, CADR, DATA, DV, and ST in the following description. In the present embodiment, the expanding data buffer (5) has four entries 0 to 3. Furthermore, the expanding data is divided into units of 256 bytes and held in the DATA in the present embodiment. Therefore, the high order 9 to 32 bits of the address are stored in the TAG as area information of the expanding data.

The expanding data buffer (5) compares the 9 to 32 bits of the read address and the value of the TAG of the plurality of entries when the read request is issued to the bus (8), and when the matching TAG is found, it outputs a signal (17), a signal (18), a signal (13), and a signal (15) from the TAG, ST, DV, and CADR of the relevant entry and outputs the data of 4 bytes selected by the low order 1 to 8 bits of the read address from the DATA of 256 bytes to the data of the bus (8), and then it outputs 1 indicating that matching TAG is found to a hit signal (16). If matching TAG is not found as a result of the comparison, 0 is outputted to the hit signal (16).

Further, the expanding data buffer (5) compares the write address and the value of the TAG of the plurality of entries when the write request is issued to an expanding data write bus (14), and when matching TAG is found, it writes the write data of the expanding data write bus (14) to ST, DV, and DATA of the relevant entry. If the matching TAG is not found as a result of the comparison, no value is written to the ST, DV, and DATA.

The data compression unit (2) reads the expanding data from the memory (4), generates the compressed data thereof, and writes the compressed data to the memory (4). Further, the data compression unit (2) selects one entry from the plurality of entries of the expanding data buffer by using the signal (9) when compressing the data, and writes 9 to 32 bits of the address of the expanding data and the address of the compressed data to the TAG and the CADR of the selected entry.

The hit detection unit (6) decodes the hit signal (16), the ST read-out signal (18), and the DV read-out signal (13) from the expanding data buffer (5), and outputs a read request mask signal (10) and an expansion start signal (21).

The logical expression of the request mask signal (10) is:
Request mask signal (10)=(hit signal (16)==1) && (DV==1).

Also, the logical expression of the expansion start signal (21) is:
Expansion start signal (21)=(hit signal (16)==1) && (DV==0) && (ST==0).

The data expansion unit (7) holds the TAG read-out signal (17) and the CDCR read-out signal (15) at the time of expansion start signal (21) assertion, and at the same time, it sets 1 to the ST of the entry having TAG that matches the TAG read-out signal held in the data expansion unit (7) through the expanding data write bus (14), reads the compressed data at the address indicated by the CDCR read-out signal held in the data expansion unit (7) from the memory through the bus (8), and then expands the compressed data. When the expansion of the compressed data is terminated, 1 and the expanded data are written to the DV and DATA of the entry having TAG that matches the TAG read-out signal held in the data expansion unit (7) through the expanding data write bus (14). Note that, although the expanding data write bus (14) includes address, control signal, and write data and the write data is further divided into ST, DV, and DATA, they are illustrated in a summarized manner in the present embodiment.

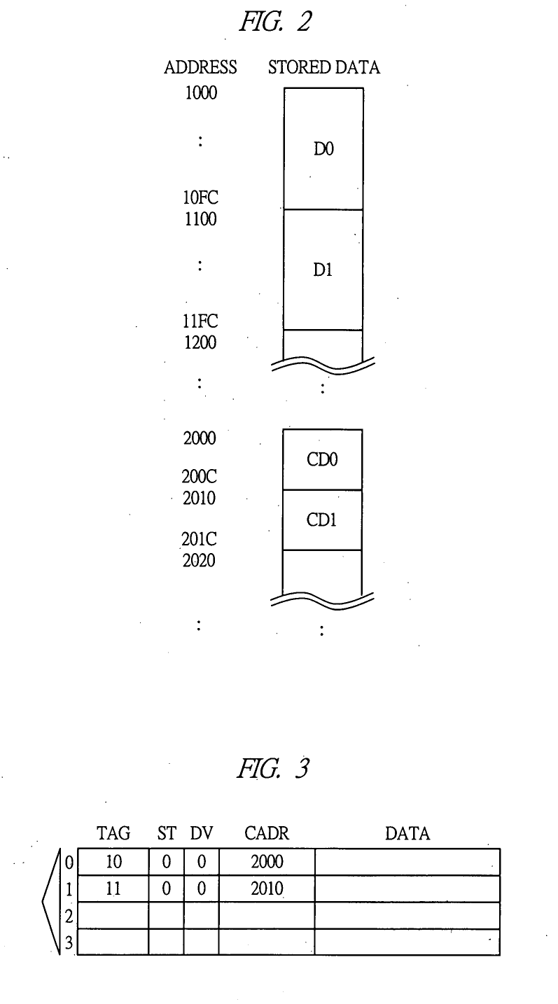

The operation of the data processing device according to the first embodiment of the present invention will be described with reference to FIG. 2 to FIG. 6.

FIG. 2 is an arrangement example on the memory (4) of the data handled by the data processing device according to the first embodiment of the present invention. The data D0 (256 bytes) is arranged in addresses 1000 to 10FC, and the data D1 (256 bytes) is arranged in addresses 1100 to 11FC. The hexadecimal notation is used for the address in the present embodiment. When the data D0 and D1 are written, the compressed data CD0 (16B) and CD1 (16B) compressed uniformly to, for example, 1/16 by the data compression unit (2) are generated, and written to the addresses 2000 to 200C and 2010 to 201C, respectively. Further, the data compression unit (2) writes TGA and CADR of entry 0 and entry 1 of the expanding data buffer (5). In this manner, the expanding data buffer (5) becomes a state shown in FIG. 3.

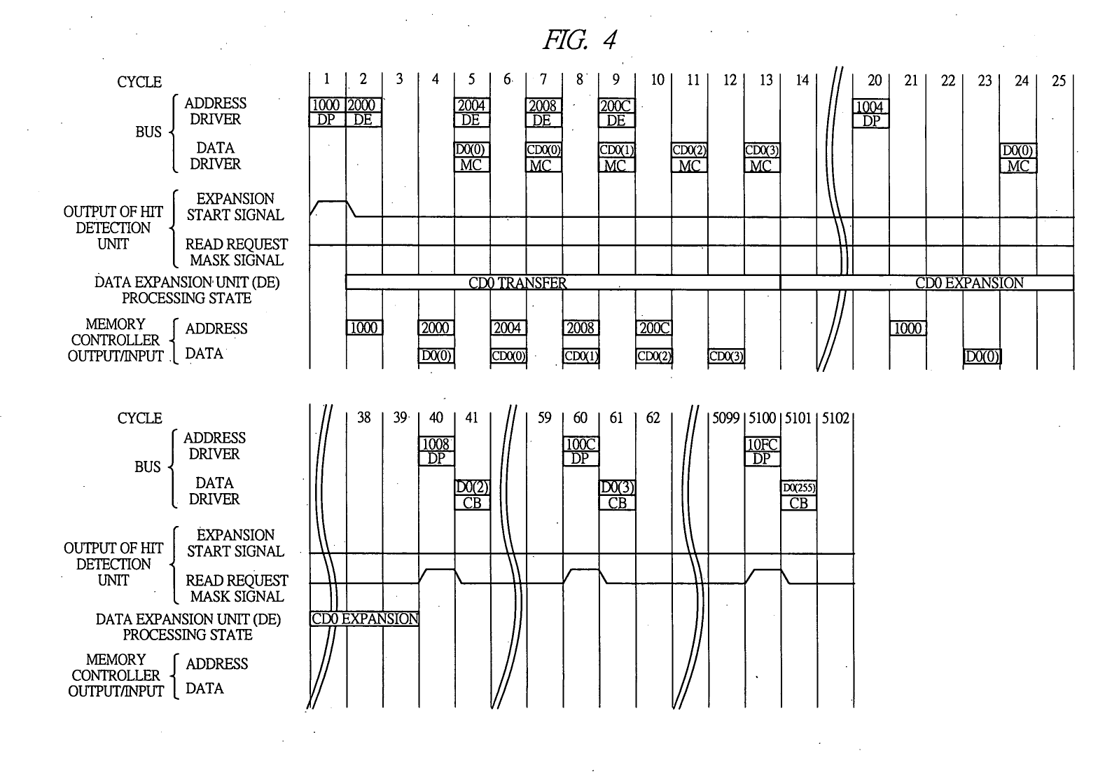

FIG. 4 is a timing chart when the data processing unit 1(11) reads the data D0 (256 bytes) of the addresses 1000 to 10FC. This timing chart shows an example where the data processing unit 1(11) sequentially reads the data of 4 bytes from the address 1000 in a constant cycle (20 cycles).

In cycle 1, the data processing unit 1(11) outputs a read request for the data of address 1000. The expression of each of the address driver and the data driver is DP: data processing unit 1(11), DE: data expansion unit (7), MC: memory controller (3), and CC: expanding data buffer (5). In this cycle, the expansion start signal (21) is asserted in accordance with the operation of the expanding data buffer (5) and the asserting condition of the expansion start signal (21) of the hit detection unit (6).

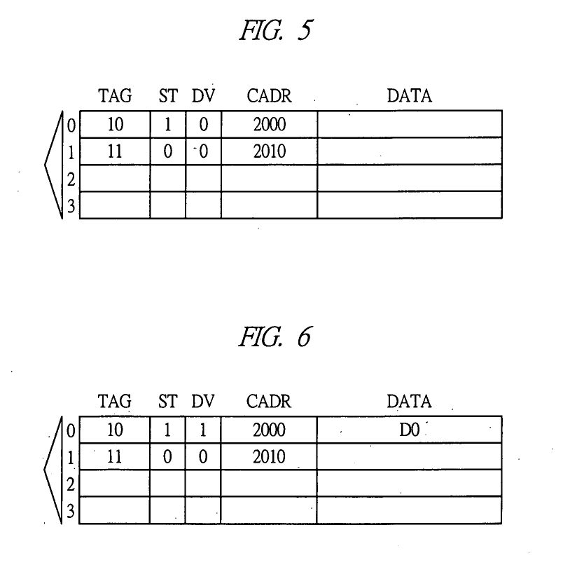

In response to the assertion of the expansion start signal, the data expansion unit (7) starts reading and expanding of the compressed data CD0 of the address 2000 to 200F from cycle 2. In the subsequent cycle 3, 1 is set to ST of the entry 0 of the expanding data buffer (5) by the operation of the expanding data buffer (5) and the data expansion unit (7), and the state shown in FIG. 5 is obtained. The data expansion unit (7) reads the CD0 four times in units of 4 bytes in cycles 2 to 13, and expands the CD0 to generate D0 in the subsequent cycles 14 to 39.

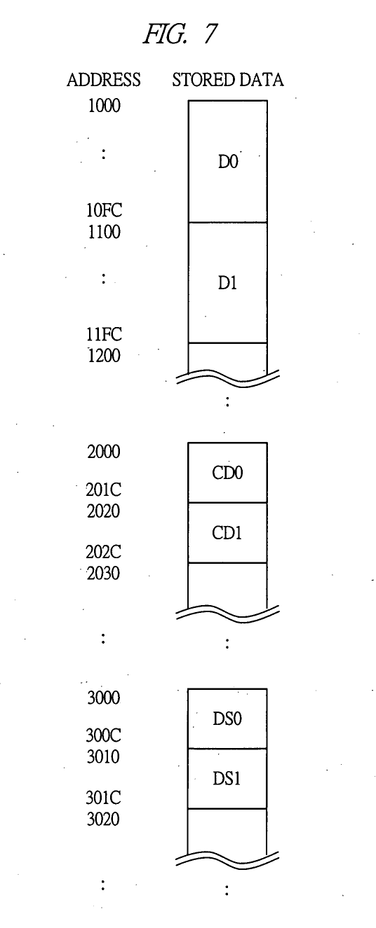

While the data expansion unit (7) expands CD0, the data processing unit 1(11) outputs a read request for data of the address 1004 in cycle 20. In cycle 20, since 1 is set to ST of the entry 0, the expansion start signal (21) is not asserted in accordance with the asserting condition of the expansion start signal (21) of the hit detection unit (6). Therefore, the expansion of the compressed data is not started redundantly. The expansion from CD0 to D0 is terminated in cycle 39, D0 is stored in DATA of the entry 0 of the expanding data buffer (5), and 1 is set to DV. The state of the expanding data buffer (5) at this time is shown in FIG. 6.

In the subsequent cycle 40, the data processing unit 1(11) outputs a read request for the data of address 1008. The read request mask signal (10) is asserted in accordance with the asserting condition of the read request mask signal (10) of the hit detection unit (6). Since the read request mask signal (10) is asserted, the data D0(2) is read by the expanding data buffer (5) in the following cycle 41 by the operation of the memory controller (3) and the expanding data buffer (5) described in FIG. 1.

Similarly, the data subsequent to the address 100C is also sequentially read by the expanding data buffer (5), a read request for the final data of D0 is outputted in cycle 5100, and the corresponding final data is read in the following cycle 5101.

As described above, the number of times of the memory access necessary to read the data D0 of 256 bytes is five according to the present embodiment, and it is possible to reduce the memory access to 5/64 in comparison to the sixty-four times in the case where the present invention is not used. Furthermore, according to the present embodiment, the access to D0 is not waited during the expansion from CD0 to D0 even if the D0 is the data that requires real-time property, and thus the real-time property is guaranteed.

### Second Embodiment

The entire configuration of the data processing device according to the second embodiment of the present invention is the same as the entire configuration (FIG. 1) of the data processing device according to the first embodiment. Therefore, detailed description thereof will be made with reference to FIG. 1. Further, the operations of the data processing unit 1(11), the data processing unit 2(12), . . . , and the data processing unit n (in), the bus (8), the memory controller (3), the memory (4), and the hit detection unit (6) are the same as the operations of the data processing device according to the first embodiment, and the detailed description of the operations thereof will be omitted in the second embodiment.

The expanding data buffer (5) includes a plurality of entries each consisting of a set of TAG for holding the area information of the expanding data, CADR for holding the address of the expansion descriptor which is information for expanding the compressed data, DATA for holding the expanding data, DV for holding the state indicating whether DATA is valid or invalid (1: valid, 0: invalid), and ST for holding the state indicating whether the expanding data is expanding or not expanding (1: expanding, 0: not expanding). In the present embodiment, the expanding data buffer (5) has four entries 0 to 3. Furthermore, the expanding data is divided into units of 256 bytes and held in the DATA in the present embodiment. Therefore, the high order 9 to 32 bits of the address are stored in the TAG as area information of the expanding data.

The expanding data buffer (5) compares the 9 to 32 bits of the read address and the value of the TAG of the plurality of entries when the read request is issued to the bus (8), and when the matching TAG is found, it outputs a signal (17), a signal (18), a signal (13), and a signal (15) from the TAG, ST, DV, and CADR of the relevant entry and outputs the data of 4 bytes selected by the low order 1 to 8 bits of the read address from the DATA of 256 bytes to the data of the bus (8), and then it outputs 1 indicating that matching TAG is found to a hit signal (16). If matching TAG is not found as a result of the comparison, 0 is outputted to the hit signal (16). Furthermore, the expanding data buffer (5) compares the 9 to 32 bits of the write address and the value of the TAG of the plurality of entries when write request is issued to the expanding data write bus (14), and when the matching TAG is found, it writes the write data of the expanding data write bus (14) to ST, DV, and DATA of the relevant entry. If the matching TAG is not found as a result of comparison, no value is written to ST, DV, and DATA.

The data compression unit (2) reads the expanding data from the memory (4), generates the compressed data thereof, and writes the compressed data and the expansion descriptor of the compressed data to the memory (4). Further, the data compression unit (7) selects one entry from the plurality of entries of the expanding data buffer by using the signal (9) when compressing the data, and writes 9 to 32 bits of the address of the expanding data and the address of the expansion descriptor of the compressed data to the TAG and the CADR of the selected entry.

The data expansion unit (7) holds the TAG read-out signal (17) and the CDCR read-out signal (15) at the time of expansion start signal (21) assertion, and at the same time, it sets 1 to the ST of the entry having TAG that matches the TAG read-out signal held in the data expansion unit (7) through the expanding data write bus (14), reads the compressed data from the memory through the bus (8) in accordance with the expansion descriptor at the address indicated by the CDCR read-out signal held in the data expansion unit (7) and then expands the compressed data. When the expansion of the compressed data is terminated, 1 and the expanded data are written to the DV and DATA of the entry having TAG that matches the TAG read-out signal held in the data expansion unit (7) through the expanding data write bus (14). Note that, although the expanding data write bus (14) includes address, control signal, and write data and the write data is further divided into ST, DV, and DATA, they are illustrated in a summarized manner in the present embodiment.

The operation of the data processing device according to the second embodiment of the present invention will be described with reference to FIG. 7 to FIG. 11.

FIG. 7 is an arrangement example on the memory (4) of the data handled by the data processing device according to the second embodiment of the present invention. The data D0 (256 bytes) is arranged in addresses 1000 to 10FC, and the data D1 (256 bytes) is arranged in addresses 1100 to 11FC. When the data D0 and D1 are written, the compressed data CD0 (32 bytes) and CD1 (16 bytes) compressed respectively to, for example, ⅛ and 1/16 are generated by the data compression unit (2), and written to the addresses 2000 to 201C and 2020 to 202C, respectively. Furthermore, the expansion descriptors DS0 and DS1 of the compressed data CD0 (32 bytes) and CD1 (16 bytes) are respectively generated by the data compression unit (2), and written to the addresses 3000 to 300C and 3010 to 301C, respectively.

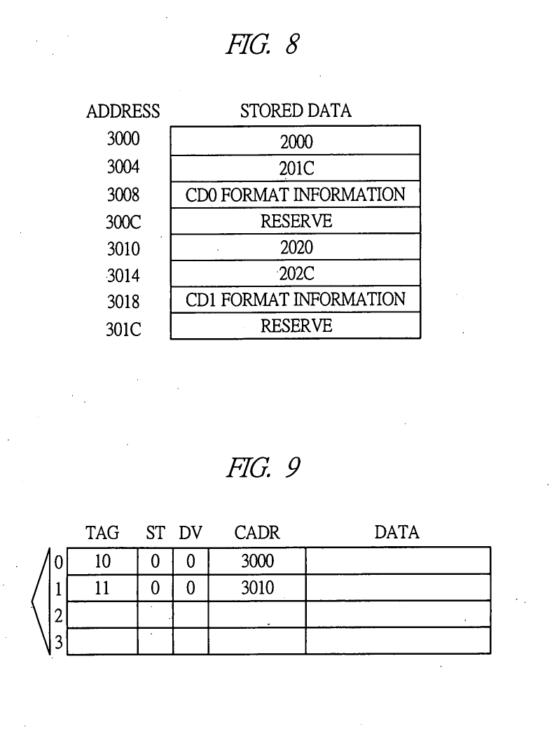

FIG. 8 shows the detail of the expansion descriptors DS0 and DS1. The expansion descriptor DS0 is configured of start address 2000, end address 201C, and format information of the corresponding compressed data CD0. Similarly, the expansion descriptor DS1 is configured of start address 2020, end address 202C, and format information of the corresponding compressed data CD1. Further, the data compression unit (2) writes TAG and CADR of the entry 0 and the entry 1 of the expanding data buffer (5), and the expanding data buffer (5) becomes the state shown in FIG. 9.

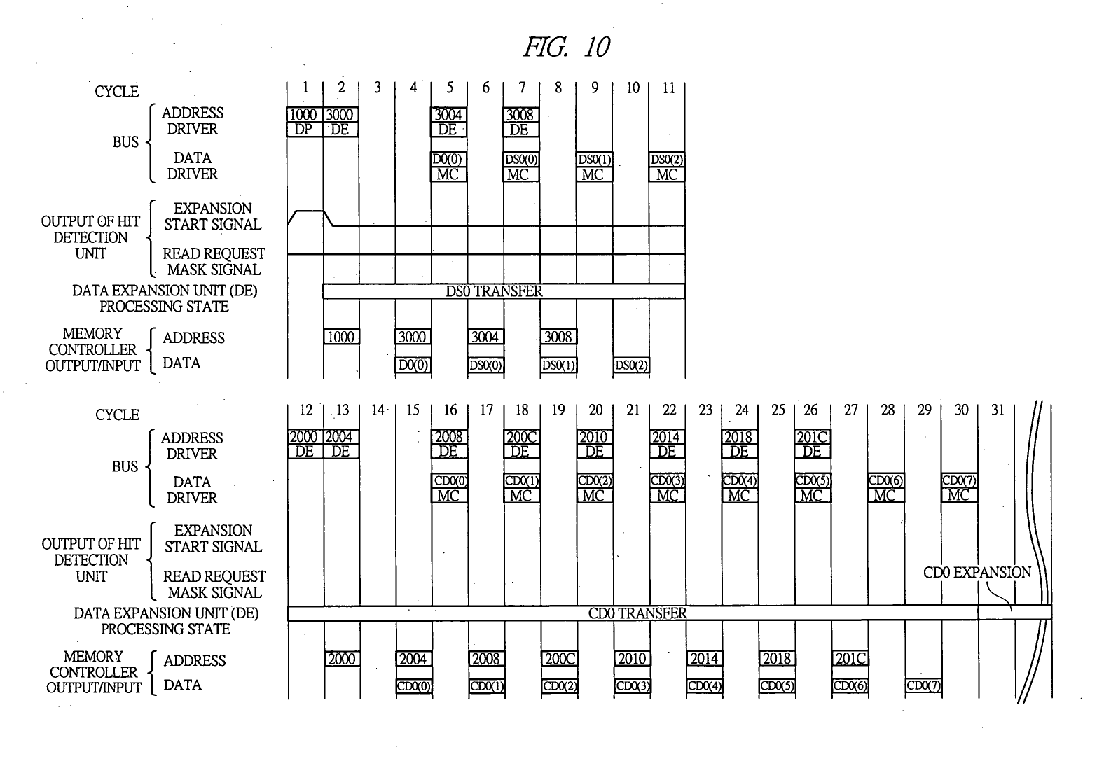

FIG. 10 is a timing chart showing the expansion from CD0 to D0 by the expanding data buffer (5) when the data processing unit 1(11) reads the data D0 (256 bytes) of the addresses 1000 to 10FC.

In cycle 1, the data processing unit 1(11) outputs a read request for the data of address 1000. In this cycle, the expansion start signal (21) is asserted in accordance with the operation of the expanding data buffer (5) and the asserting condition of the expansion start signal (21) of the hit detection unit (6) described in the first embodiment.

In response to the assertion of the expansion start signal, the data expansion unit (7) reads the expansion descriptor DS0 of addresses 3000 to 300C in cycles 2 to 11 by the operation of the expanding data buffer (5) and the data expansion unit (7). In the following cycles 12 to 30, CD0 of addresses 2000 to 201C is read in accordance with the start address and the end address of the CD0 indicated by the expansion descriptor DS0. D0 is expanded from CD0 in accordance with the format information of the expansion descriptor DS0 from the subsequent cycle 31.

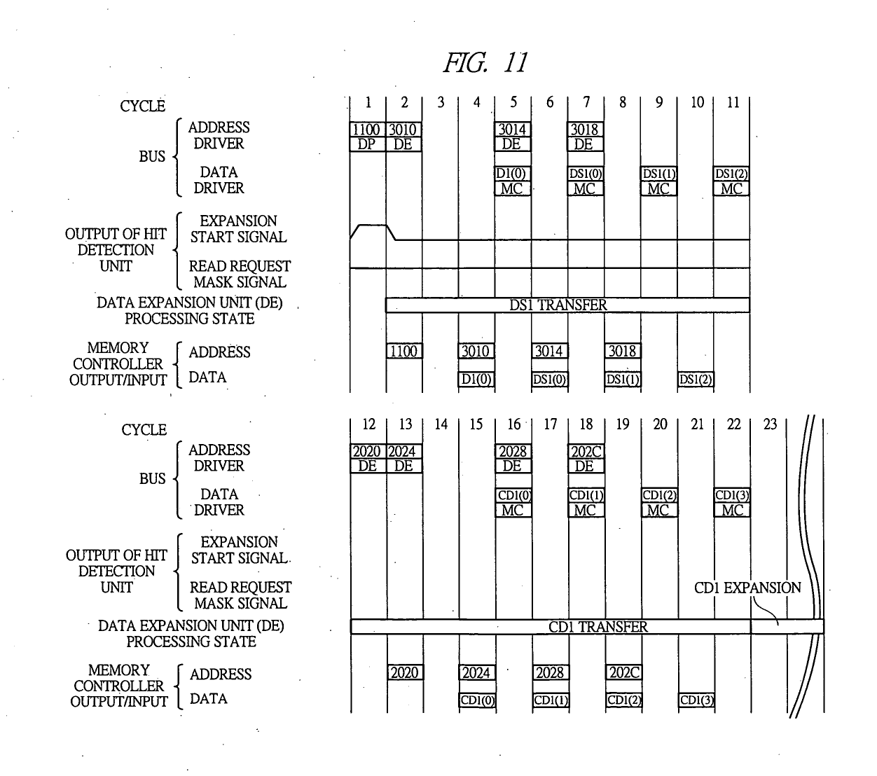

FIG. 11 is a timing chart showing the expansion from CD1 to D1 by the expanding data buffer (5) when the data processing unit 1(11) reads the data D1 (256 bytes) of addresses 1100 to 11FC.

In cycle 1, the data processing unit 1(11) outputs a read request for the data of address 1100. In this cycle, the expansion start signal (21) is asserted in accordance with the operation of the expanding data buffer (5) and the asserting condition of the expansion start signal (21) of the hit detection unit (6) described in the first embodiment.

In response to the assertion of the expansion start signal, the data expansion unit (7) reads the expansion descriptor DS1 of addresses 3010 to 301C in cycles 2 to 11 by the operation of the expanding data buffer (5) and the data expansion unit (7) described in the present embodiment. In the following cycles 12 to 22, CD1 of address 2020 to 202C is read in accordance with the start address and the end address of the CD1 indicated by the expansion descriptor DS1. D1 is expanded from CD1 in accordance with the format information of the expansion descriptor DS1 from the subsequent cycle 23.

As described in FIG. 10 and FIG. 11, in addition to the advantages of the first embodiment, a plurality of compression methods of different compression rates and formats can be handled in the present embodiment. Therefore, the use for a wide range of applications becomes possible.

In the foregoing, the invention made by the inventors of the present invention has been concretely described based on the embodiments. However, it is needless to say that the present invention is not limited to the foregoing embodiments and various modifications and alterations can be made within the scope of the present invention.

The present invention relates to a technology for a data processing device, and in particular, it can be used for a technology for a data transfer among a plurality of data processing units.

What is claimed is:

1. A data processing device comprising: a plurality of data processing units; and a memory commonly accessed by the plurality of data processing units, in which the plurality of data processing units transfer transfer data via the memory,
wherein the memory holds the transfer data and compressed data of the transfer data.

2. The data processing device according to claim 1, further comprising an expanding data buffer which includes a plurality of entries each configured of a set of:
a storage element TAG for holding area information where the transfer data is to be stored;
a storage element CADR for holding an address of the compressed data;
a storage element DATA for holding the transfer data;
a storage element DV for holding a state indicating whether the transfer data is valid or invalid; and
a storage element ST for holding a state indicating whether the transfer data is expanding or not expanding.

3. The data processing device according to claim 2,
wherein, when generating the compressed data of the transfer data and writing the compressed data to the memory, one entry is selected from the plurality of entries of the expanding data buffer, and the area information where the transfer data is to be stored and the address of the compressed data are respectively stored in the storage element TAG and the storage element CADR of the selected entry.

4. The data processing device according to claim 3,
wherein, when the data processing unit reads the transfer data from the memory, an entry in which an area indicated by the storage element TAG thereof contains the address of the transfer data is searched from the plurality of entries,
if the entry exists, the storage element CADR, the storage element DV, and the storage element ST of the entry are read,
when the read storage element DV indicates an invalid state and the read storage element ST indicates a not expanding state, the expansion of the compressed data at the address indicated by the storage element CADR starts, and simultaneously, a state indicating an expanding state is set to the storage element ST of the entry, and
when generation of the expanded data is completed, the expanded data is stored in the storage element DATA of the entry, and simultaneously, a state indicating a valid state is set to the storage element DV of the entry.

5. The data processing device according to claim 4,
wherein, when the data processing unit reads the transfer data from the memory, an entry in which the area indicated by the storage element TAG thereof contains the address of the transfer data is searched from the plurality of entries,
if the entry exists, the storage element DV of the entry is read,
when the read storage element DV indicates the valid state, the data processing unit reads the expanded data from the storage element DATA of the entry, and
when the read storage element DV indicates the invalid state or if the entry does not exist, the data processing unit reads the transfer data from the memory.

6. A data processing device comprising: a plurality of data processing units; and a memory commonly accessed by the plurality of data processing units, in which the plurality of data processing units transfer transfer data via the memory,
wherein the memory holds the transfer data, compressed data of the transfer data, and expansion descriptor which is information for expanding the compressed data.

7. The data processing device according to claim 6, further comprising an expanding data buffer which includes a plurality of entries each configured of a set of:
a storage element TAG for holding area information where the transfer data is to be stored;
a storage element CADR for holding an address of the expansion descriptor;
a storage element DATA for holding the transfer data;
a storage element DV for holding a state indicating whether the transfer data is valid or invalid; and
a storage element ST for holding a state indicating whether the transfer data is expanding or not expanding.

8. The data processing device according to claim 7,
wherein, when generating the compressed data of the transfer data and writing the compressed data to the memory, one entry is selected from the plurality of entries of the expanding data buffer, and the area information where the transfer data is to be stored and an address of the expansion descriptor are respectively stored in the storage element TAG and the storage element CADR of the selected entry.

9. The data processing device according to claim 8,
wherein, when the data processing unit reads the transfer data from the memory, an entry in which an area indicated by the storage element TAG thereof contains the address of the transfer data is searched from the plurality of entries,
if the entry exists, the storage element CADR, the storage element DV, and the storage element ST of the entry are read,
when the read storage element DV indicates an invalid state and the read storage element ST indicates a not expanding state, the expansion of the compressed data starts in accordance with a content of the expansion descriptor at the address indicated by the storage element CADR, and simultaneously, a state indicating an expanding state is set to the storage element ST of the entry, and
when generation of the expanded data is completed, the expanded data is stored in the storage element DATA of the entry, and simultaneously, a state indicating a valid state is set to the storage element DV of the entry.

10. The data processing device according to claim 9,
wherein, when the data processing unit reads the transfer data from the memory, an entry in which the area indicated by the storage element TAG thereof contains the address of the transfer data is searched from the plurality of entries,
if the entry exists, the storage element DV of the entry is read,
when the read storage element DV indicates the valid state, the data processing unit reads the expanded data from the storage element DATA of the entry, and
when the read storage element DV indicates the invalid state or if the entry does not exist, the data processing unit reads the transfer data from the memory.
